(19) United States
(12) Patent Application Publication
(10) Pub. No.: US 2015/0289659 A1
(43) Pub. Date: Oct. 15, 2015

(54) FIRE RETARDANT SEAT PAD

(71) Applicant: YAO I FABRIC CO., LTD., Chang-Hwa County (TW)

(72) Inventor: NORMAN TAO, CHANG-HWA COUNTY (TW)

(73) Assignee: YAO I FABRIC CO., LTD., Chang-Hwa County (TW)

(21) Appl. No.: 14/248,427

(22) Filed: Apr. 9, 2014

(51) Int. Cl. A47C 7/16; C09D 5/18

(52) U.S. Cl. CPC A47C 7/16; C09D 5/18

(57) ABSTRACT

A fire retardant seat pad includes an elastic member which comprises plastic wires which are wound to form a fixed and stereoscopic shape. The plastic wires are fixed to each other at contact positions, and apertures are formed between the plastic wires. The coefficient of elasticity is adjustable during the manufacturing processes of the plastic wires. An elastic body is shaped to be matched with the elastic member. A fire-retardant fabric coat is mounted to the elastic member and the elastic body. The elastic member and the elastic body provide good cushion feature, and the fire-retardant fabric coat makes the seat pad be fire-proof.

### BACKGROUND OF THE INVENTION

1. Fields of the Invention

The present invention relates to a seat pad, and more particularly, to a seat pad or backrest of a seat which is elastic, fire-proof and air permeable.

2. Descriptions of Related Art

The conventional seat pad is composed of a foam pad coated and a fabric coat is coated to the foam pad. However, the foam pad is easily get on fire. In order to increase the protection and safety to the users, the safety seats are developed and which use fire retardant material. A method for making the safety fire retardant seat pads is disclosed in U.S. Pat. No. 5,085,487. The safety seat pad comprises a foam pad to which a netted layer, a fire retardant layer and a fire retardant decoration layer are mounted.

U.S. Pat. No. 7,827,637 further discloses a seat pad which has a moisture-proof layer and a fire retardant layer respectively coated to the foam pad.

Both of the disclosed seat pads lack satisfied elasticity and the feature of the fire-proof is needed to be improved.

The present invention intends to provide a seat pad which has better elasticity and uses better fire retardant material to improve the shortcomings mentioned above.

### SUMMARY OF THE INVENTION

The present invention relates to a fire retardant seat pad and comprises an elastic member which comprises plastic wires and the plastic wires are wound to form a fixed and stereoscopic shape. The plastic wires are fixed to each other at contact positions, and apertures are formed between the plastic wires that are not in contact with each other. An elastic body is shaped to be matched with the elastic member. A fire-retardant fabric coat is mounted to the elastic member and the elastic body.

Preferably, the elastic member is made by a foam body or upright and honeycomb-shaped elastic foam.

Preferably, the fire-retardant fabric coat comprises a fabric coated with fire-retardant material.

Preferably, the fire-retardant fabric coat comprises a fabric which comprises a base which is based on oxidized fibers, and blend fire-retardant fibers.

Preferably, the fire-retardant fabric coat comprises a fabric which is a needle felt composed of 100% of oxidized fibers.

Preferably, the fire-retardant fabric coat comprises a fabric which is a KEVLAR fabric.

The primary object of the present invention is to provide a seat pad which comprises an elastic member and an elastic body so as to provide better elastic feature and to prolong the life of use. The seat pad bounces back when the user stands up and leaves from the seat pad.

Another object of the present invention is to provide a seat pad which includes apertures in the elastic body for air to be permeable. The elastic body is coated by the fire-retardant fabric coat, and can be used as a float in water.

Yet another object of the present invention is to provide a seat pad wherein the fire-retardant fabric coat is fire-proof. If the fire-retardant fabric coat is coated with fire retardant coatings, the fire-retardant fabric coat does not drip, collapse and is not carbonized in fire. The fire-retardant fabric coat stops the expansion of the fire. The fire-retardant fabric coat can be made by oxidized fibers which is the precursor of the carbon fibers, and is partially carbonized by Polyacrylonitrile (PAN). The fire-retardant fabric coat does not get on fire, does not melt, and is isolation to electricity and chemical hazard material. The fire-retardant fabric coat does not shrink under high temperature. Alternatively, the fire-retardant fabric coat is a KEVLAR fabric.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the seat pad of the present invention;

FIG. 2 is an exploded view of the seat pad of the present invention;

FIG. 3 is a cross sectional view of the seat pad of the present invention, and

FIG. 4 shows that the seat pad of the present invention is used as a seat and a backrest of a chair.

### DETAILED DESCRIPTION OF THE PREFERRED EMBODIMENT

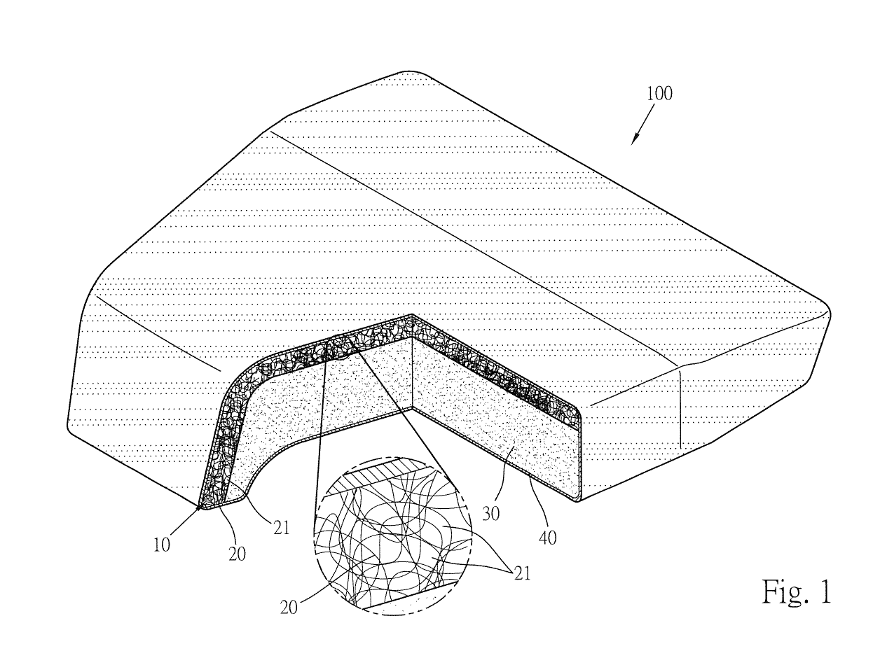

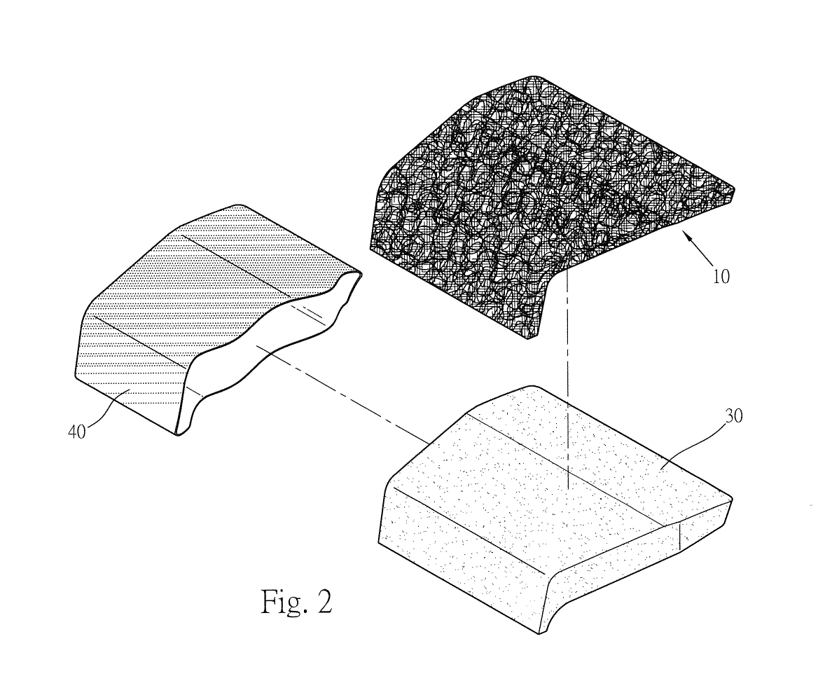

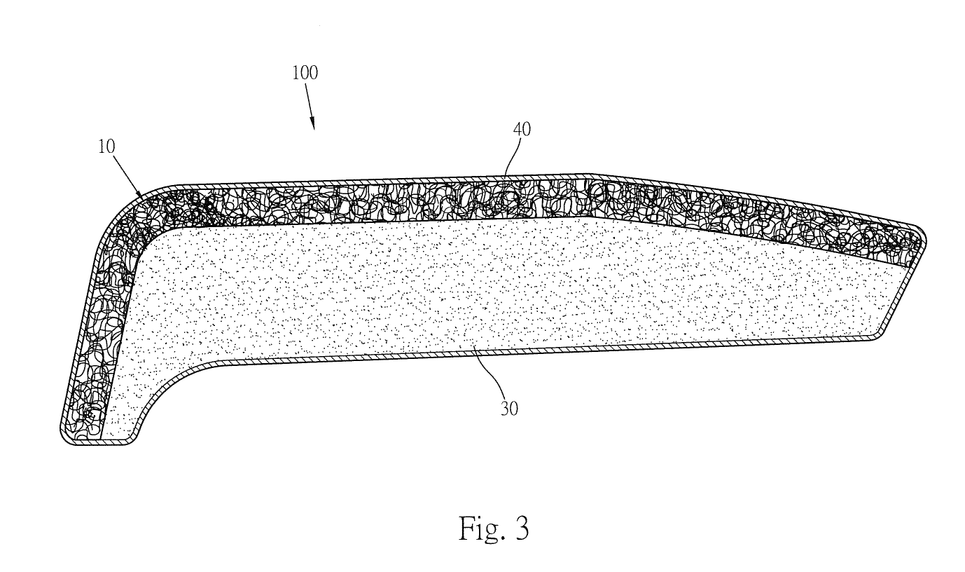

Referring to FIGS. 1 to 3, the fire retardant seat pad 100 of the present invention comprises an elastic member 10 which comprises plastic wires 20 which are wound to form a fixed and stereoscopic shape. The plastic wires 20 are fixed to each other at contact positions, and apertures 21 are formed between the plastic wires 20 that are not in contact with each other. The apertures 21 are multiple and have different sizes. In detail, the plastic wires 20 are formed by putting melting plastic material in molds. The plastic wires 20 are wound in melted status so that when any two plastic wires 20 are in contact with each other, the contact positions are fixed to each other when being cooled, while the apertures 21 are formed between the plastic wires 20 that are not in contact with each other after the plastic wires 20 are cooled. The cooled product is then shaped and trimmed to form the elastic member 10. The density and coefficient of the elastic member 10 can be adjusted during manufacturing processes.

An elastic body 30 is shaped so as to be matched with the elastic member 10. A fire-retardant fabric coat 40 is then mounted to the elastic member 10 and the elastic body 30. The foam for making the elastic body 30 is Ethylene Vinyl Acetate (EVA) or Polyethylene (PE) based foam. Alternatively, the elastic member 10 can be made by upright elastic foam with homey-comb cross section. The upright elastic foam at least comprises two different fibers with elasticity and self-crimp. The two different fibers are melted and shrunk to be connected to each other so as to form evenly spiral and highly crimped foam. When the melted fibers are cooled, the foam has the homey-comb cross section.

The fire-retardant fabric coat 40 comprises a fabric coated with fire-retardant material, the fire-retardant fabric coat 40 is difficult to get on fire and can be used to stop the fire. Even if the fire-retardant fabric coat 40 is on fire, the fire-retardant fabric coat 40 can last for a longer time.

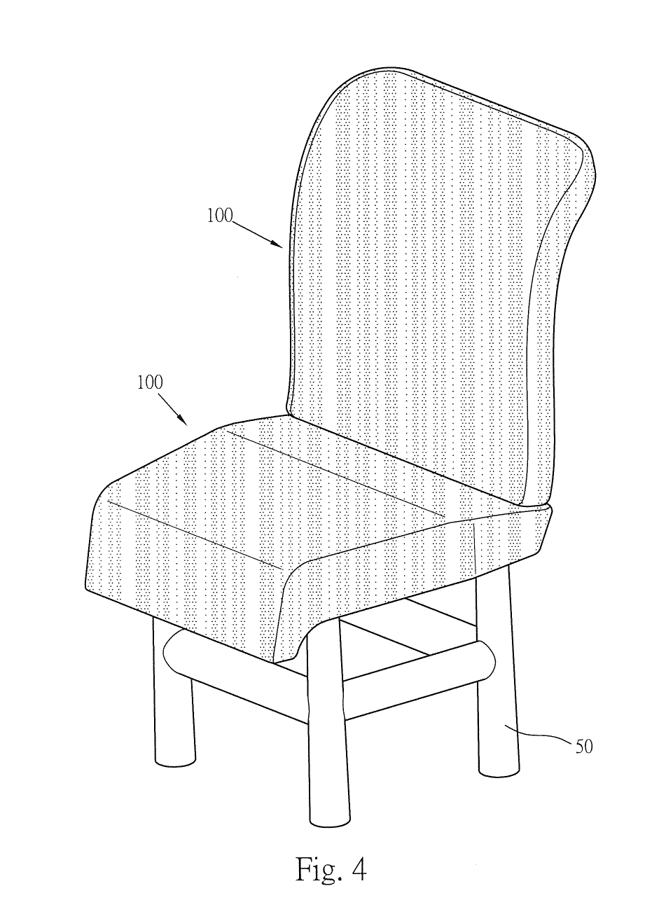

Further referring to FIG. 4, the fire retardant seat pad 100 of the present invention is installed to a frame 50 and used as a seat portion or a backrest of a seat. The seat can be used for vehicles, ships, planes and other traffic devices. The fire retardant seat pad 100 of the present invention provide better fire-proof feature and can be used as a float for it has multiple apertures 21.

The density and coefficient of the elastic member 10 and the elastic body 30 can be adjusted during manufacturing processes. The thickness of the elastic body 30 can be adjusted, and the sequence of the connection between the elastic member 10 and the elastic body 30 can be adjusted. The elastic body 30 can be replaced by using the elastic member 10 of different coefficient of elasticity.

The fire-retardant fabric coat 40 is difficult to get on fire and can be used to stop the fire. Even if the fire-retardant fabric coat 40 is on fire, the fire-retardant fabric coat 40 can last for a longer time to provide the user to have more time to escape. The fire-retardant fabric coat 40 comprises a fabric coated with a fire-proof layer which is a mixture of a liquid adhesive, graphite, and an expansion agent. When the fabric is on fire, the expansion agent expands to absorb the flammable liquid to form a protection layer. The fabric does not drip under high temperature. The graphite has high melting point so that the fire-retardant fabric coat 40 does collapse and maintain the shape of the object so that the fire is stopped and cannot expanded to other parts. The fabric of fire-retardant fabric coat 40 comprises a base and blend fire-retardant fibers, the base is based on oxidized fibers. The fabric of fire-retardant fabric coat 40 provides permanent fire-stop feature, and performs better than the standards of heat-isolation, heat-radiating and heat-refraction. The fabric of fire-retardant fabric coat 40 is not burned, shrunk, carbonized or decomposed under high temperature. When the fire-retardant fabric coat 40 is directly exposed to fire, the fibers absorb the oxygen and remove the components that are flammable, and the fibers removes the heat away from the fabric of fire-retardant fabric coat 40. Alternatively, the fabric of the fire-retardant fabric coat 40 can be a needle felt composed of 100% of oxidized fibers or a KEVLAR fabric.

While we have shown and described the embodiment in accordance with the present invention, it should be clear to those skilled in the art that further embodiments may be made without departing from the scope of the present invention.

What is claimed is:

1. A fire retardant seat pad comprising:
an elastic member which comprises plastic wires which are wound to form a fixed and stereoscopic shape, the plastic wires being fixed to each other at contact positions, apertures being formed between the plastic wires that are not in contact with each other;
an elastic body being shaped to be matched with the elastic member, and
a fire-retardant fabric coat mounted to the elastic member and the elastic body.

2. The fire retardant seat pad as claimed in claim 1, wherein the elastic member is made by a foam body.

3. The fire retardant seat pad as claimed in claim 1, wherein the elastic member is made by upright elastic foam.

4. The fire retardant seat pad as claimed in claim 1, wherein the fire-retardant fabric coat comprises a fabric coated with fire-retardant material.

5. The fire retardant seat pad as claimed in claim 1, wherein the fire-retardant fabric coat comprises a fabric which comprises a base which is based on oxidized fibers, and blend fire-retardant fibers.

6. The fire retardant seat pad as claimed in claim 1, wherein the fire-retardant fabric coat comprises a fabric which is a needle felt composed of 100% of oxidized fibers.

7. The fire retardant seat pad as claimed in claim 1, wherein the fire-retardant fabric coat comprises a fabric which is a KEVLAR fabric.
